(19) United States
(12) Patent Application Publication
(10) Pub. No.: US 2019/0232440 A1
(43) Pub. Date: Aug. 1, 2019

(54) SELF-PROPELLED MACHINE FOR HANDLING OF LOADS

(71) Applicant: Idrojet S.r.l., Camporotondo Etneo (IT)

(72) Inventors: Danilo LA FERLA, Santa Maria di Licodia (IT); Francesco VIGLIANTI, Sant'Agata Li Battiati (IT)

(21) Appl. No.: 16/341,003

(22) PCT Filed: Oct. 14, 2016
(86) PCT No.: PCT/IT2016/000238

§ 371 Date: Apr. 10, 2019

(51) Int. Cl. B23P 19/02; B66C 9/04

(52) U.S. Cl. CPC B23P 19/024; B66C 9/04

(57) ABSTRACT

The present invention relates to a self-propelled machine, particularly for the aerial handling of loads, even medium-length loads, such as for example tube bundles or the like.

### CROSS-REFERENCE TO RELATED APPLICATION

This application is a 35 U.S.C. § 371 National Phase of PCT Application No. PCT/IT2016/000238 filed Oct. 14, 2016, the disclosure of which is incorporated in its entirety by reference.

### BACKGROUND

The present invention relates to a self-propelled machine, in particular for the aerial handling of loads, even medium-length loads, such as for example tube bundles or the like.

A machine according to the present invention is used in particular on the oil platforms wherein very reduced overall dimensions are required, in particular in height and as far as the possibilities of manoeuvring in restricted spaces are concerned.

This machine can be used both as lift truck and as device for handling medium-length loads.

On machines of this type, even a bidirectional hydraulic winch can be assembled on the lift mount, which winch can be used as extractor for example for tube bundles.

Furthermore as on the oil platforms, and however wherever the manoeuvring space should be equally reduced, there is an evident difficulty in making the machine to rotate on itself, to drive through 90-degree turns, etc.

All this even considering that they are machines the weight thereof is about 22.5 tons which have to bear loads of 15 tons, at the height of about ⅘ meters from the ground.

### SUMMARY

The object of the present invention is then to overcome the above-illustrated problems and this is obtained by means of a self-propelled machine as defined in claim 1.

Additional features of the present invention are defined in the corresponding depending claims.

The present invention, by overcoming the problems of known art, involves several and evident advantages.

In particular, a machine according to the present invention can be moved by means of wheels capable of steering to vary the forwarding direction by over 180°.

Furthermore, the actuation of each wheel group of the machine can take place independently from the other ones, for the maximum directionality and manoeuvrability.

### BRIEF DESCRIPTION OF THE DRAWINGS

Other advantages, together with the features and use modes of the present invention, will result evident from the following detailed description of preferred embodiments thereof, shown by way of example and not for limitative purpose. In the following description the enclosed figures will be referred to, wherein:

FIGS. 1A to 1C are overall views of a machine according to the present invention; and

FIGS. 2A to 2E are views of a wheel group of a machine according to the present invention.

### DETAILED DESCRIPTION

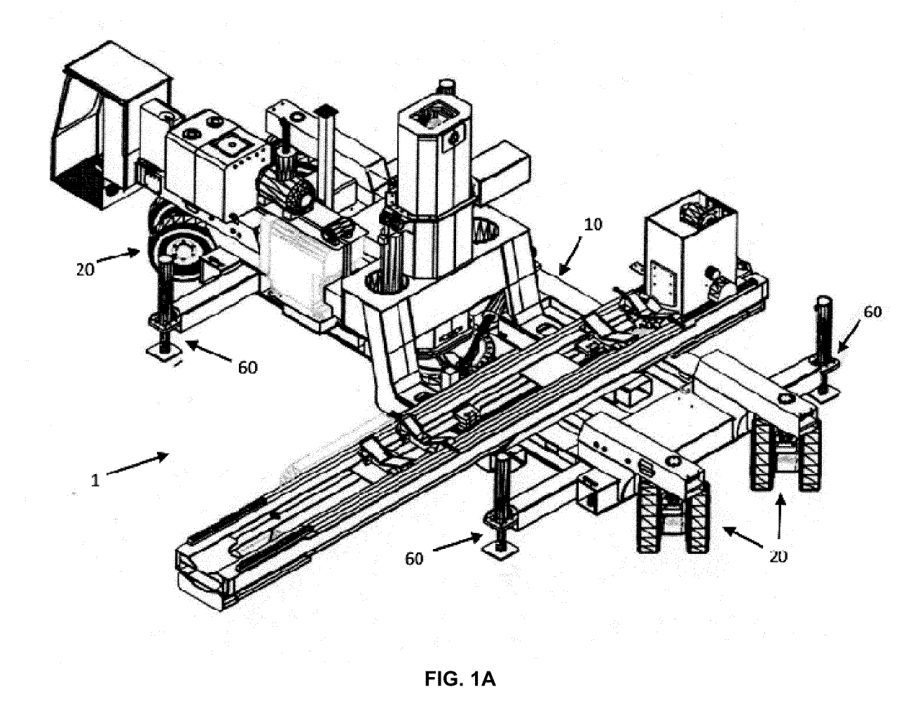

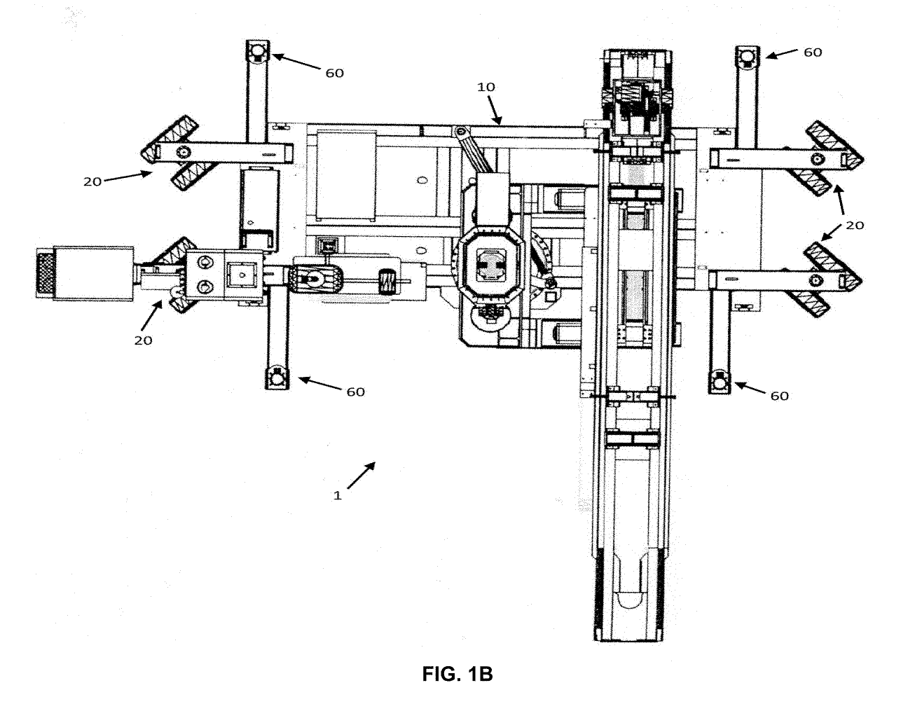

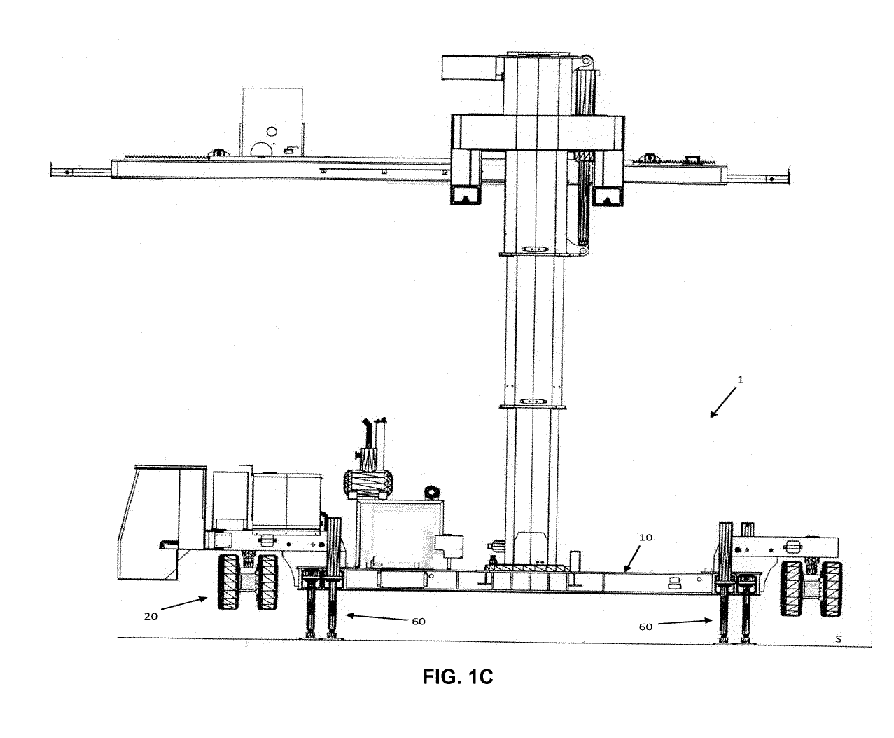

By firstly referring to FIGS. 1A to 1C, they represent overall views of a machine 1 according to the present invention.

In general terms, the self-propelled machine 1 comprises a primary supporting frame 10 configured to house an apparatus for handling a load.

The machine 1, for moving onto the ground, comprises at least three wheel groups 20, preferably the machine 1 comprises four wheel groups 20.

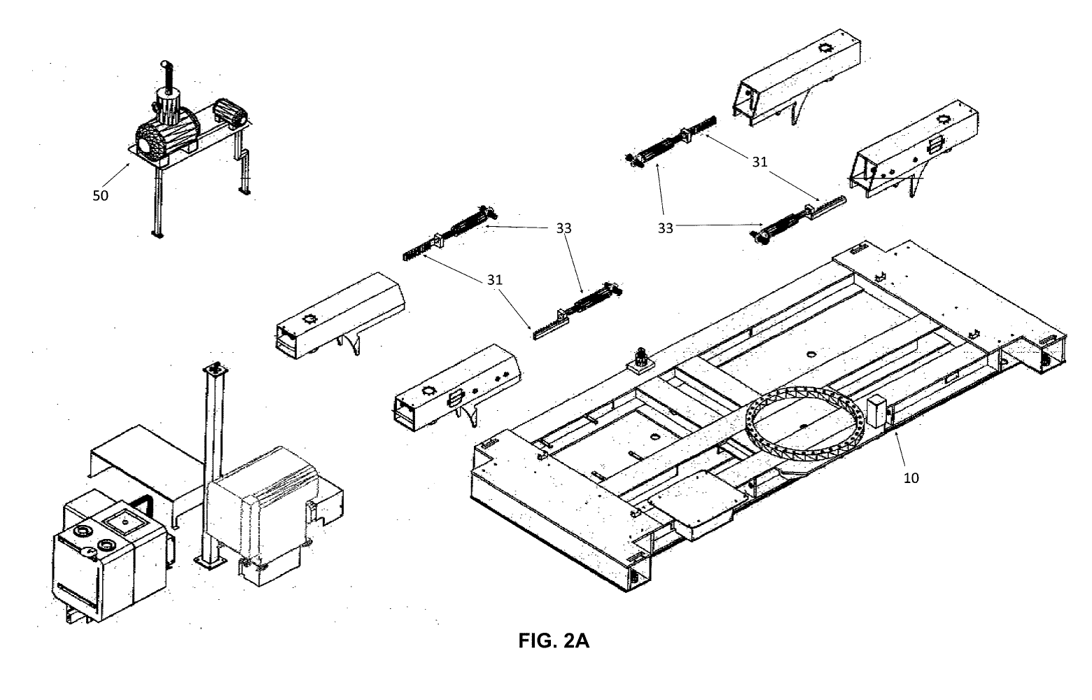

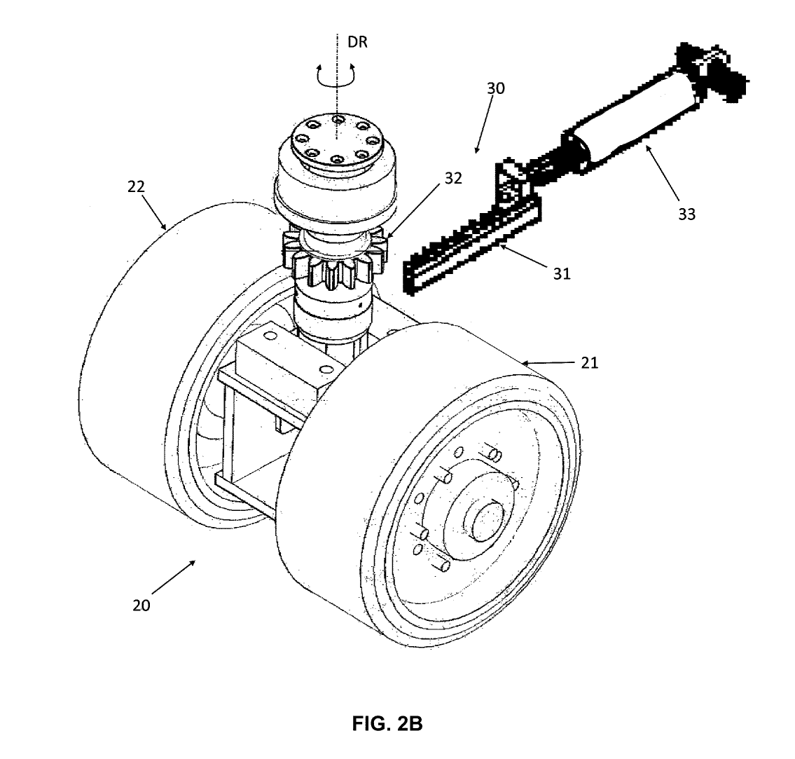

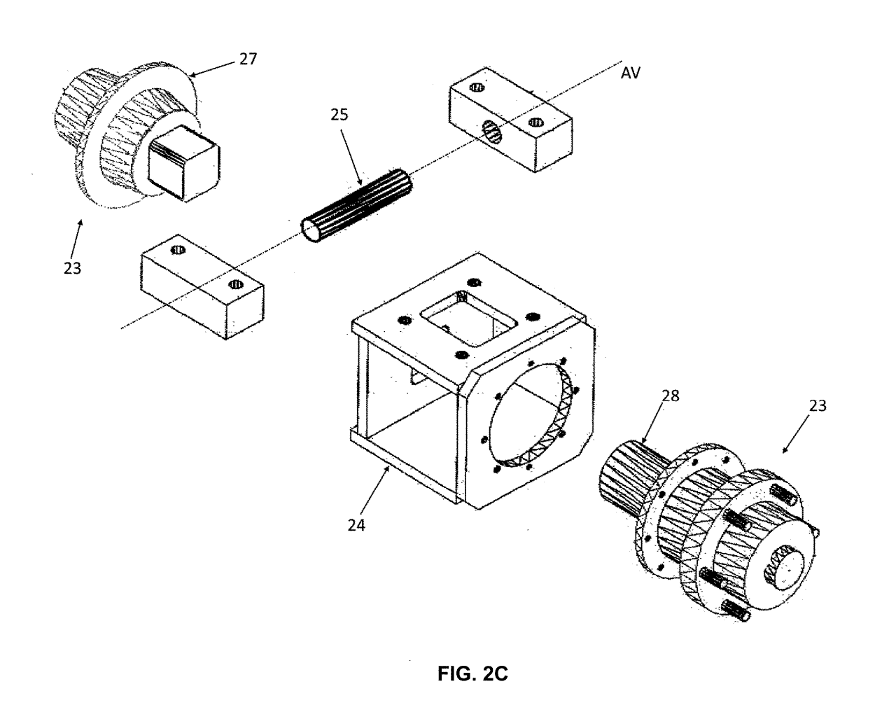

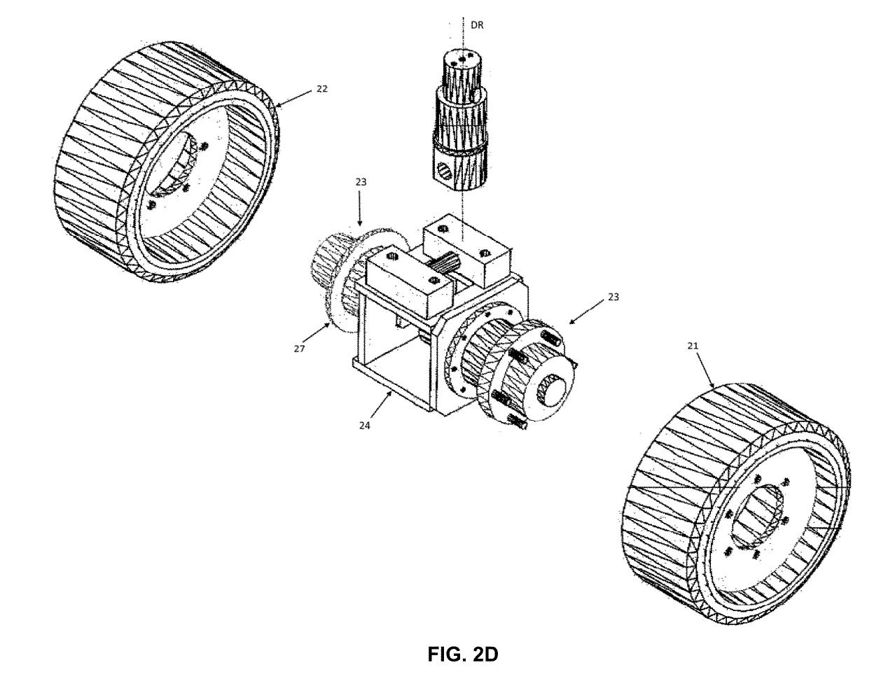

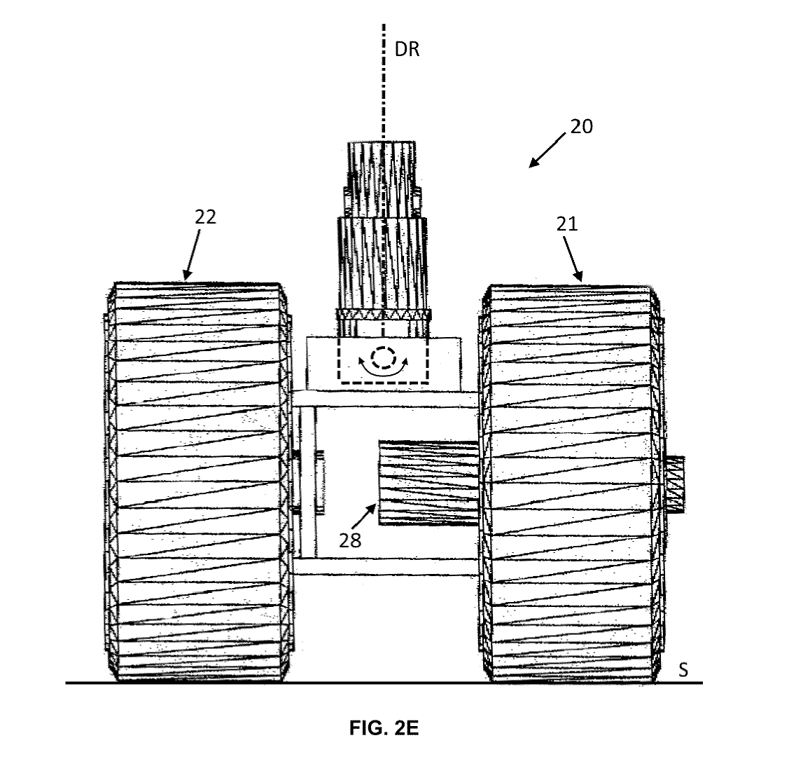

FIGS. 2A-2E relate to details to a single wheel group 20.

In particular each wheel group 20 comprises at least a pair of twin wheels 21, 22 assembled on respective hubs 23.

Of such wheels of each pair of twin wheels, at least one is motor-operated and thus it is a driving wheel, with reduction gear and hydraulic engine 28.

According to the preferred embodiment, only one of the two wheels is a driving wheel, whereas the second one is assembled in an idle way.

Advantageously, each wheel group 20 further comprises an independent dampening system 40.

In particular, the two wheels 21, 22 of each pair of twin wheels are connected to a hub-holding frame 24, in turn connected to the dampening system 40 which, according to an embodiment, comprises for each wheel group 20, a damper made of two-density polyurethane.

Furthermore, each wheel group 20 comprises a directional system 30 configured to vary the forwarding direction AV of the twin wheels 21, 22 independently from the other wheel groups 20 of the machine.

According to a preferred embodiment of the invention, the directional system, for each wheel group 20, comprises a rack 31 which engages on a toothed wheel 32 integral with a rotation shaft DR of the wheel group 20, substantially orthogonal to the ground.

The rack 31 advantageously is actuated by means of a respective hydraulic piston 33.

The configuration of the steering system is so as to be able to vary the forwarding direction of each wheel group by over 180°.

Advantageously, each pair of wheels is connected to the dampening system 40 by means of a connecting element 25, for example a central axis, configured to implement a swivelling connection apt to allow an oscillation of the wheel group around an axis AV substantially parallel to the ground and coincident with the forwarding direction of the wheel group 20.

The swivelling system of the pairs of wheels and the elastic suspension thereof in the vertical direction allow, even on irregular ground, the contemporary contact of all wheels to the ground.

Moreover, each wheel group 20 advantageously can comprise a braking system 26, comprising for example at least a disc brake 27 assembled onto the hub of one of the wheels 21, 22 of the wheel group 20.

As far as the motorization and the actuation of devices on board the machine are concerned, the machine 1 comprises an internal combustion engine 50, for example a diesel engine, equipped with a transmission shaft splitter configured to move both a variable-displacement open-circuit hydraulic pump and a variable-displacement closed-circuit hydraulic pump.

The first one advantageously can be used to feed all services of the machine itself (cylinders, engines, etc.), the second one, which belongs to a hydrostatic system, can feed the translation engines assembled on the reduction gears of the wheels.

In fact, as already said, at least one of the two twin wheels is motorized, and preferably it is so by means of a hydrostatic motorization group comprising a hydraulic engine and a reduction gear.

Moreover, at least according to an embodiment, a machine according to the present invention can comprise at least three extendable hydraulic stabilisers 60, apt to lift the machine with respect to the ground. This allows a considerable shift of the loads around the lifting telescopic arm which rotates vertically around its own axis and the rotation thereof is 90°.

The machine can be equipped with wheels made of solid rubber tyre or with special wheels having the tyres coated with a material made of synthetic resin allowing to reduce the height from the ground of the machine itself.

In particular, a machine according to the invention equipped with four wheel groups, the wheels thereof are coated with polyurethane (diameter 500 mm), can have a loading capacity reaching 60 tons (7.5 T on each one of the eight wheels), or, if it is equipped with rubber tired wheels (diameter 693 mm), the loading capacity can reach 40 tons (5 T on each one of the eight wheels).

At last, according to some embodiments, the machine 1 can further comprise a remote-controlled and/or radio-controlled system for guiding and/or controlling the hydraulic handling.

In particular for guiding the machine a remote-controlled system can be provided, whereas for all other motions (lifting, etc.) actuated by hydraulic cylinders both the remote-controlled functions and the radio-controlled functions are provided.

The present invention has been so far described by referring to preferred embodiments thereof, together with some embodiment variants. It is to be meant that each one of the variants and of the technical solutions implemented in the preferred embodiments, herein described by way of example, could advantageously be combined differently therebetween, to create other embodiments, belonging to the same inventive core and all however within the protection scope of the herebelow reported claims.

1. A self-propelled machine comprising a primary supporting frame configured to house an apparatus for handling a load, the self-propelled machine comprising at least three wheel groups for the shifting onto the ground of the self-propelled machine, wherein each wheel group comprises:
at least a pair of twin wheels assembled on respective hubs, at least one wheel of the pair being motorized;
an independent dampening system; and
a directional system configured to vary a forwarding direction of the twin wheels independently from other wheel groups.

2. The self-propelled machine according to claim 1, wherein the twin wheels of each pair of the at least a pair of twin wheels of each respective wheel group are connected to a hub-holding frame, in turn connected to the dampening system.

3. The self-propelled machine according to claim 1, wherein each pair of twin wheels is connected to the dampening system via a connecting element configured to implement a swivelling connection which allows for oscillation of each respective wheel group around an axis that is substantially parallel to the ground and coincident with the forwarding direction of the respective wheel group.

4. The self-propelled machine according to claim 1, wherein each wheel group further comprises a braking system.

5. The self-propelled machine according to claim 4, wherein the braking system comprises at least a disc brake assembled onto the hub of one of the wheels of the at least a pair of twin wheels of each respective wheel group.

6. The self-propelled machine according to claim 1, wherein the directional system of each wheel group, comprises a rack which engages on a toothed wheel integral with a rotation shaft of the respective wheel group substantially orthogonal to the ground.

7. The self-propelled machine according to claim 1, wherein the dampening system, of each wheel group, comprises a damper made of two-density polyurethane.

8. The self-propelled machine according to claim 1, wherein the at least one wheel of each wheel group being motorized is motorized via a hydrostatic motorization group comprising a hydraulic engine and a reduction gear.

9. The self-propelled machine according to claim 1, comprising an internal combustion engine equipped with a transmission shaft splitter configured to move a variable-displacement open-circuit hydraulic pump and a closed-circuit hydraulic pump.

10. The self-propelled machine according to claim 1, further comprising at least three extendable hydraulic stabilizers configured to lift the self-propelled machine with respect to the ground.

11. The self-propelled machine according to claim 8, further comprising a remote-controlled or radio-controlled system for guiding or controlling the hydrostatic motorization group.

12. The self-propelled machine according to claim 1, further comprising an extractor of tube bundles assembled on said primary supporting frame.
